(19) United States
(12) Patent Application Publication
(10) Pub. No.: US 2025/0304067 A1
(43) Pub. Date: Oct. 2, 2025

(54) VEHICLE SYSTEM FOR EASY ACCESS TO CARGO COMPARTMENT

(71) Applicant: Ford Global Technologies, LLC, Dearborn, MI (US)

(72) Inventors: Andreas Puetz, Kelmis/DG (BE); Ahmed Benmimoun, Aachen/NRW (DE); Thomas Nowak, Aldenhoven/Nordrhein-Westfalen (DE); Mohsen Lakehal-ayat, Aachen/NRW (DE)

(73) Assignee: Ford Global Technologies, LLC, Dearborn, MI (US)

(21) Appl. No.: 19/085,288

(22) Filed: Mar. 20, 2025

(30) Foreign Application Priority Data
Mar. 28, 2024 (DE) 102024108907.5

(51) Int. Cl. B60W 30/17; B60W 10/30; B60W 30/18; E05F 15/73

(52) U.S. Cl. CPC B60W 30/17; B60W 10/30; B60W 30/18036; E05F 15/73; B60W 2554/4041; B60W 2554/4045; B60W 2554/802; B60W 2754/30; E05Y 2400/44; E05Y 2900/546

(57) ABSTRACT

A motor vehicle has a front, a rear, a driving direction directed from the rear to the front, a reverse driving direction which is directed in the opposite direction to the driving direction, a cargo compartment access point and a cargo compartment which is accessible via the cargo compartment access point. A user of the motor vehicle can be detected located outside the motor vehicle and in the reverse driving direction from the motor vehicle. In the event that the user moves away from the motor vehicle in the reverse driving direction, the motor vehicle can follow the user in that the motor vehicle drives autonomously in the reverse driving direction; It can be determined whether the user intends to reach into the cargo compartment. In the event that the answer is yes, the motor vehicle can drive autonomously to a standstill of the motor vehicle, in such a way that a loading distance between the cargo compartment access point and the user is finely adjusted.

### CROSS-REFERENCE TO RELATED APPLICATION

This patent application claims priority to German Application No. DE 102024108907.5 filed on Mar. 28, 2024, which is hereby incorporated by reference in its entirety.

### BACKGROUND

In an autonomously driving motor vehicle, there are applications in which a driver of the motor vehicle sits in the motor vehicle while the motor vehicle is driving autonomously, and applications in which the driver is outside the motor vehicle and the motor vehicle follows the driver autonomously. In the applications in which the vehicle follows the driver, it is conceivable that the driver performs activities in which the driver repeatedly reaches into the vehicle to remove objects from the vehicle. For example, the driver can perform a delivery service in which the objects are delivered to customers. In another example, the objects may be traffic cones that the driver places on a road at regular intervals. Under certain circumstances, the vehicle may follow the driver in such a way that it comes to a stop at positions that require the driver to travel long distances in order to reach into the vehicle and take the objects to a specific location.

### SUMMARY

This disclosure includes a technique for operating a motor vehicle in which a user is located outside the motor vehicle and the motor vehicle drives autonomously in such a way that the user only has to cover short distances in order to repeatedly reach into the motor vehicle. The disclosure further includes a computer program and a storage medium for carrying out methods and techniques herein.

The method according to the disclosure is for operating a motor vehicle having a front, a rear, a driving direction directed from the rear to the front, a reverse driving direction opposite to the driving direction, a cargo compartment access point and a cargo compartment accessible via the cargo compartment access point. The method comprises the steps of: a) detecting a user of the motor vehicle located outside the motor vehicle and in the reverse driving direction from the motor vehicle; b) in the case that the user moves away from the motor vehicle in the reverse driving direction, the motor vehicle following the user by autonomously driving the motor vehicle in the reverse driving direction; c) querying (i.e., determining) whether the user intends to reach into the cargo compartment; d) in the event that the answer in step c) is yes, the motor vehicle autonomously driving to a standstill of the motor vehicle, in such a way that a loading distance between the cargo compartment access point and the user is finely adjusted.

Since the motor vehicle follows the user in the reverse driving direction in step b) and the cargo compartment is generally located in the region of the rear of a motor vehicle, it is advantageously not necessary for the user to walk around the entire motor vehicle in order to reach the cargo compartment, so that the user therefore only has to cover short distances in order to reach the cargo compartment. By fine-tuning the loading distance in step d), the distance to be covered by the user can be shortened even further. After the vehicle has come to a standstill in step d), the method can be continued with step b). As a result, the user has the repeated adjustments even if the user repeatedly reaches into the cargo compartment.

In order to detect the user in step a), the motor vehicle can have a sensor. The sensor can, for example, be one or more of a camera, in particular a camera system that is set up to fully capture the environment around the motor vehicle, a LIDAR system, a radar system and a Bluetooth system. The aforementioned systems can also be provided to perform the querying (determining) in step c).

It is preferred that in step c) the querying (determining) comprises determining whether the user remains stationary. Alternatively or additionally, it is preferred that in step c) the determining comprises determining whether the user is facing towards the motor vehicle.

In step b), a minimum distance can be maintained between the motor vehicle and the user. This can advantageously prevent a collision between the motor vehicle and the user. The minimum distance can be in the range of 1.5 m to 3 m, for example. It is typically preferable that the loading distance is shorter than the minimum distance. This allows the distance that the user has to cover to be shortened even further. The loading distance can be in the range of 0.3 m to 1.2 m, for example.

The loading distance can be set by the user. In this way, a rather large user can select a rather longer loading distance and a rather small user can select a rather shorter loading distance. This allows each user to choose the optimum loading distance for them.

The motor vehicle has a door which has a closed state, in which the cargo compartment is not accessible via the cargo compartment access point, and an open state, in which the cargo compartment is accessible via the cargo compartment access point. The door can be arranged in the region of the rear of the motor vehicle.

It is possible that in the event that the answer in step c) is yes and the door is in the closed state, a query (determination) is made in step e) as to whether the user wishes the door to be opened, and, in the event that the answer is yes, the door is moved from the closed state to the open state in step f). The determination in step e) can be carried out using the sensor, for example. It is possible that in step e) it is detected whether the user has a free hand, and, if the answer is no, this is interpreted as meaning that the user wishes the door to be opened. For example, it can be detected whether the user is carrying something in both hands and, if this is detected, it is evaluated that the user does not have a free hand. Alternatively or additionally, it is possible that in step e) it is detected whether the user performs a predetermined gesture, and, if the answer is yes, it is evaluated that the user wishes the door to be opened.

It is possible that, in the event that in step a), in addition to the user, an object is detected which is located within a maximum distance from the user, a query (i.e., determination) is made in step b1) as to whether the user is pointing at the object, and, in the event that the answer in step b1) is yes, the motor vehicle is driven autonomously until the motor vehicle comes to a standstill in such a way that a predetermined motor vehicle distance is set between the motor vehicle and the object. This allows the user to instruct the motor vehicle to position the motor vehicle in relation to the object rather than in relation to the user. It is possible that, in the event that the answer in step b1) is yes, the motor vehicle is driven autonomously until the motor vehicle comes to a standstill, in such a way that a predetermined motor vehicle orientation is set between the motor vehicle and the object.

The loading distance possible depends on whether the door is in the closed state or in the open state. In the closed state, the loading distance can be selected to take into account that the door must pivot in order to be moved from the closed state to the open state and that a collision of the door with the user is avoided. For example, the loading distance can be longer in the closed state than in the open state.

It is possible that the cargo compartment access point is located at the rear. This means that the distance that the user has to cover is advantageously short.

In step a), the user detects various objects in the surroundings of the motor vehicle and the route taken by the vehicle while driving autonomously is planned on the basis of the surrounding objects. In this way, a collision of the motor vehicle with the surrounding objects can be avoided.

The motor vehicle is adapted to carry out the method according to the disclosure.

The computer program according to the disclosure has instructions which, when the program is executed by a computer of a motor vehicle, cause it to carry out the method according to the disclosure.

The computer-readable storage medium has instructions which, when executed by a computer of a motor vehicle, cause it to carry out the method according to the disclosure.

### BRIEF SUMMARY OF THE DRAWINGS

The disclosure is explained in greater detail below with reference to the accompanying schematic drawings, in which:

FIG. 1 is a plan view of a motor vehicle and of a user at a first point in time,

FIG. 2 shows the view from FIG. 1 at a second point in time,

FIG. 3 shows the view from FIG. 1 at a third point in time,

FIG. 4 shows the view from FIG. 1 at a fourth point in time, and

FIG. 5 is a plan view of a motor vehicle and of a user at three different points in time.

### DESCRIPTION

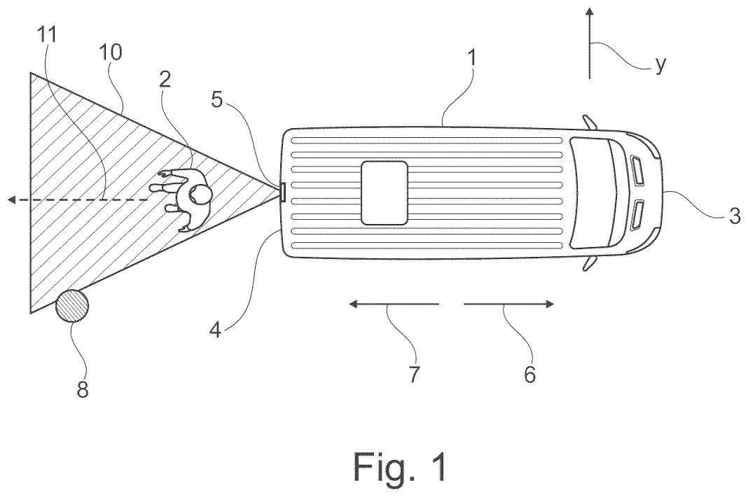

As can be seen from FIGS. 1 to 5, a motor vehicle 1 has a front 3, a rear 4, a driving direction 6 directed from the rear 4 to the front 3, a reverse driving direction 7 which is directed in the opposite direction to the driving direction 6, a cargo compartment access point 5 and a cargo compartment which is accessible via the cargo compartment access point 5, wherein the cargo compartment is accessible in particular from outside the motor vehicle 1 via the cargo compartment access point 5. The motor vehicle 1 is set up to perform the following steps: a) detecting a user 2 of the motor vehicle 1 located outside the motor vehicle 1 and in the reverse driving direction 7 of the motor vehicle 1; b) in the event that the user 2 moves away from the motor vehicle 1 in the reverse driving direction 7, the motor vehicle 1 following the user 2 in that the motor vehicle 1 drives autonomously in the reverse driving direction 7; c) querying (i.e., determining) whether the user 2 intends to reach into the cargo compartment; d) in the event that the answer in step c) is yes, the motor vehicle 1 driving autonomously to a standstill of the motor vehicle 1, in such a way that a loading distance between the cargo compartment access point 5 and the user 2 is finely adjusted. After the motor vehicle 1 has come to a standstill in step d), the method can be continued with step b), wherein the user 2 is detected during the entire method.

The motor vehicle 1 can have a sensor that is set up to detect the user 2 in step a). The sensor can have a field of view 10 (see FIGS. 1 to 4), within which the user 2 can be detected. The sensor can be one or more of a camera, in particular a camera system that is set up to fully capture the environment around the motor vehicle, a LIDAR system, a radar system and a Bluetooth system. The Bluetooth system can be set up to communicate with a device worn by the user. The sensor may also be set up to perform the querying (determining) in step c).

FIGS. 1 to 4 show the method at four different points in time, wherein the time progresses from FIG. 1 to FIG. 4. FIG. 1 shows that, in step a), the motor vehicle detects the user 2, who is positioned in the reverse direction 7 of the motor vehicle 1 and moves in the reverse direction 7 and along a path 11 away from the motor vehicle 1. As a result, in step b), the motor vehicle 1 follows the user 2 as the motor vehicle 1 drives autonomously in the reverse driving direction 7. In step b), a minimum distance between the motor vehicle 1 and the user 2 can be maintained. The minimum distance can be such that a collision between the motor vehicle 1 and the user 2 can be avoided. The minimum distance can be in the range of 1.5 m to 3 m, for example.

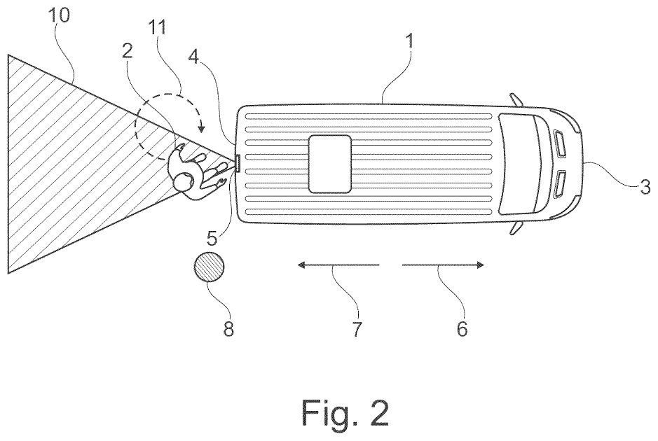

While the motor vehicle 1 follows the user 2, it can be determined in step c) whether the user 2 intends to reach into the cargo compartment. The determination (query) in step c) can include whether the user 2 remains standing and/or whether the user 2 is facing in the direction of the motor vehicle 1. Whether the user 2 is facing towards the motor vehicle 1 can be determined, for example, by checking whether the face of the user 2 is visible. FIG. 2 shows that the user 2 reaches a setdown location 8, stops, and turns around so that they are facing towards the motor vehicle 1. Thus, in step c), the intention of the user 2 to reach into the cargo compartment is recognized, whereupon the loading distance is finely adjusted in step d). The loading distance can be shorter than the minimum distance. For example, the loading distance can be in the range of 0.3 m to 1.2 m.

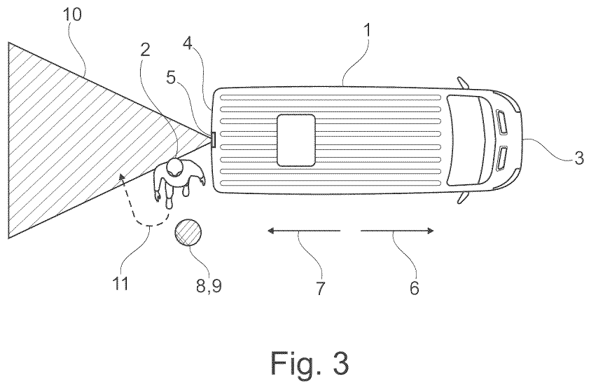

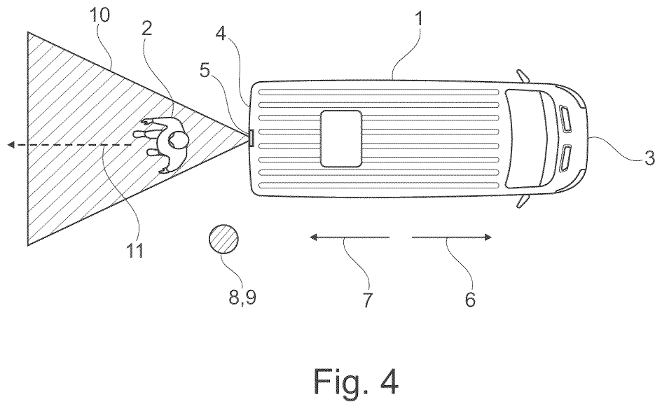

FIG. 3 shows that the user 2 has removed an object 9 from the cargo compartment and placed it at the setdown location 8. The object 9 may be a traffic cone, for example. FIG. 4 shows that the user 2 moves away from the motor vehicle 1 again in the reverse direction 7 and along the path 11, so that the method starts again from the beginning.

The motor vehicle 1 can have a door that has a closed state, in which the cargo compartment is not accessible via the cargo compartment access point 5, and an open state, in which the cargo compartment is accessible via the cargo compartment access point 5. In one example, in the case where the motor vehicle 1 is a passenger car, the door may be a tailgate. In another example, if the motor vehicle 1 is a van, the door may be a cargo compartment door.

In the event that the answer in step c) is yes and the door is in the closed state, a determination can be made in step e) as to whether the user 2 wishes the door to be opened and, in the event that the answer is yes, the door can be moved autonomously from the closed state to the open state by the motor vehicle 1 in step f). It is possible that the determination is carried out in step e) by means of the sensor. In step e), it is possible to detect whether the user 2 has a free hand, and, if the answer is no, this can be interpreted as meaning that the user 2 wishes the door to be opened, and/or in step e), it is possible to detect whether the user 2 performs a predetermined gesture, and, if the answer is yes, this can be interpreted as meaning that the user 2 wishes the door to be opened.

The loading distance (see FIG. 2) can be adjustable by the user 2 and/or can depend on whether the door is in the closed or in the open position. It is also conceivable that the loading distance in the closed state is longer than in the open state.

FIGS. 1 to 5 show that the cargo compartment access point 5 can be arranged in such a way that the user 2 reaches into the cargo compartment in the direction of travel 6 via the cargo compartment access point 5. The cargo compartment access point 5 can be arranged in the region of the rear 4 for this purpose. The cargo compartment access point 5 can, for example, be located in the y-direction (see FIG. 1) of the motor vehicle 1 in the middle of the motor vehicle. Alternatively, it is conceivable that the cargo compartment access point 5 is located in the y-direction in the middle of a vehicle opening which is covered by the door when the latter is closed and which is open when the latter is open.

It is conceivable that, in the event that in step a) an object 9 is detected in addition to the user 2 and is located within a maximum distance from the user 2, a query (determination) is made in step b1) as to whether the user 2 is pointing at the object 9, and, in the event that the answer in step b1) is yes, the motor vehicle 1 is driven autonomously until the motor vehicle 1 comes to a standstill in such a way that a predetermined motor vehicle distance is set between the motor vehicle 1 and the object 9. The query (determination) in step b1) can be made using the sensor. In the event that the answer in step b1) is yes, the motor vehicle 1 is driven autonomously until the motor vehicle 1 comes to a standstill in such a way that a predetermined motor vehicle orientation is set between the motor vehicle 1 and the object 9.

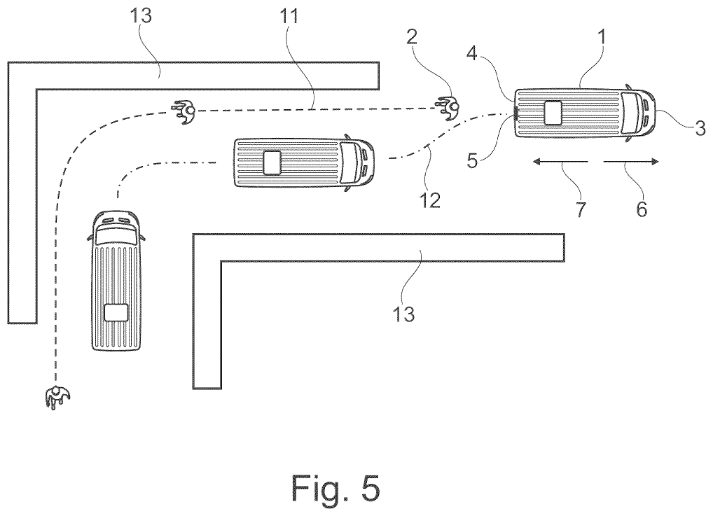

FIG. 5 shows that, in step a), various surrounding objects 13 of the motor vehicle 1 can be detected by the user 2, and the path of travel 12, which is covered by the motor vehicle 1 while the motor vehicle 1 is driving autonomously, is planned on the basis of the surrounding objects 13. Because the motor vehicle 1 is traveling in the reverse driving direction 7, the path of travel 12 can be planned in such a way that a maximum steering angle of the motor vehicle 1 is used; see in FIG. 5 in particular the path of travel between the motor vehicle 1 at the second point in time and the third point in time.

### LIST OF REFERENCE SIGNS

1 motor vehicle
2 user
3 front
4 rear
5 cargo compartment access point
6 driving direction
7 reverse driving direction
8 setdown location
9 object
10 field of view
11 path
12 route
13 surrounding object

1-18. (canceled)

19. A method, comprising:
detecting a user of a motor vehicle located outside the motor vehicle and in a reverse driving direction of the motor vehicle;
upon detecting the user moving away from the motor vehicle in the reverse driving direction, moving the motor vehicle to follow the user in the reverse driving direction while maintaining a minimum distance between the user and the motor vehicle; and
upon determining that the user intends to reach into a cargo compartment of the motor vehicle, stopping the motor vehicle when an access point of a cargo compartment of the motor vehicle is within a loading distance of the user;
wherein the loading distance is less than the minimum distance.

20. The method of claim 19, wherein determining that the user intends to reach into a cargo compartment of the motor vehicle includes determining whether the user is stationary.

21. The method of claim 19, wherein determining that the user intends to reach into the cargo compartment of the motor vehicle includes determining whether the user is facing toward the motor vehicle.

22. The method of claim 19, wherein the loading distance is adjustable by the user.

23. The method of claim 19, wherein the motor vehicle includes a door having a closed state in which the cargo compartment is not accessible via the access point, and an open state in which the cargo compartment is accessible via the access point.

24. The method of claim 23, further comprising, when the door is in the closed state upon determining that the user intends to reach into the cargo compartment of the motor vehicle, determining whether the user wishes the door to be opened and, in the event that the answer is yes, moving the door from the closed state to the open state.

25. The method of claim 23, further comprising moving the door to the open state upon detecting that the user does not have a free hand and/or upon detecting that the user has performed a predetermined gesture.

26. The method of claim 23, wherein the loading distance depends on whether the door is in the closed state or in the open state.

27. The method of claim 19, wherein, in addition to detecting the user, upon detecting an object a maximum distance from the user, determining whether the user is pointing at the object, and, if so, moving the motor vehicle until the motor vehicle comes to a standstill according to a predetermined distance between the motor vehicle and the object.

28. The method of claim 27, wherein, upon determining that the user intends to reach into the cargo compartment of the motor vehicle, moving the motor vehicle until the motor vehicle comes to a standstill in such a way that a predetermined motor vehicle orientation is set between the motor vehicle and the object.

29. A computer for a motor vehicle, programmed to:
detect a user of a motor vehicle located outside the motor vehicle and in a reverse driving direction of the motor vehicle;
upon detecting the user moving away from the motor vehicle in the reverse driving direction, move the motor vehicle to follow the user in the reverse driving direction while maintaining a minimum distance between the user and the motor vehicle; and
upon determining that the user intends to reach into a cargo compartment of the motor vehicle, stopping the motor vehicle when an access point of a cargo compartment of the motor vehicle is within a loading distance of the user;
wherein the loading distance is less than the minimum distance.

30. The computer of claim 29, further programmed to determine that the user intends to reach into a cargo compartment of the motor vehicle includes determining whether the user is stationary.

31. The computer of claim 29, further programmed to determine that the user intends to reach into a cargo compartment of the motor vehicle including by determining whether the user is facing toward the motor vehicle.

32. The computer of claim 29, wherein the loading distance is adjustable by the user.

33. The computer of claim 29, wherein the motor vehicle includes a door having a closed state in which the cargo compartment is not accessible via the access point, and an open state in which the cargo compartment is accessible via the access point.

34. The computer of claim 33, further programmed to, when the door is in the closed state upon determining that the user intends to reach into a cargo compartment of the motor vehicle, determine whether the user wishes the door to be opened and, in the event that the answer is yes, move the door from the closed state to the open state.

35. The computer of claim 33, further programmed to move the door to the open state upon detecting that the user does not have a free hand and/or upon detecting that the user has performed a predetermined gesture.

36. The computer of claim 33, wherein the loading distance depends on whether the door is in the closed state or in the open state.

37. The computer of claim 29, further programmed to, in addition to detecting the user, upon detecting an object a maximum distance from the user, determine whether the user is pointing at the object, and, if so, move the motor vehicle until the motor vehicle comes to a standstill according to a predetermined distance between the motor vehicle and the object.

38. The computer of claim 37, further programmed to, upon determining that the user intends to reach into the cargo compartment of the motor vehicle, move the motor vehicle until the motor vehicle comes to a standstill in such a way that a predetermined motor vehicle orientation is set between the motor vehicle and the object.
